(19) United States
(12) Patent Application Publication
(10) Pub. No.: US 2010/0274672 A1
(43) Pub. Date: Oct. 28, 2010

(54) Systems And Methods For Tone Based Telephonic Advertising

(76) Inventor: Yogesh Patel, Mountain View, CA (US)

Correspondence Address: LATHROP & GAGE LLP, 4845 PEARL EAST CIRCLE, SUITE 201, BOULDER, CO, 80301, US

(21) Appl. No.: 12/766,592

(22) Filed: Apr. 23, 2010

Related U.S. Application Data
(60) Provisional application No. 61/172,085, filed on Apr. 23, 2009.

(51) Int. Cl. G06Q 30/00; H04M 1/64; H04M 3/493

(52) U.S. Cl. 705/14.66; 379/88.23; 455/414.2

(57) ABSTRACT

Systems, methods and software products advertising over a telecommunication device. One or more audio advertisements are received from at least one advertiser, each audio advertisement having zero, one or more associated advertizing criteria. One or more user profiles defining advertisement options for a subscriber of a service provider are received. For each subscriber, zero, one or more of the audio advertisements are selected based upon the user profile and the advertizing criteria associated with the audio advertisements. The selected audio advertisements are installed as one or more of dial tone, ring tone, call tone and busy tone for the subscriber.

### RELATED APPLICATIONS

This application claims priority to U.S. Patent Application Ser. No. 61/172,085, filed Apr. 23, 2009, and incorporated herein by reference.

### BACKGROUND

When a user A calls user B, user B hears a ring tone selected by user B. Where user B has a default call tone (also known as a ringback tone), as typically provided by their carrier, user A will hear that call tone when placing a call to user B. Alternatively, user B may select a custom call tone (e.g., by paying money to the carrier) such as a song, a jingle or a favorite audio selection.

A ringback tone is a status indicator that the dialed number is available (i.e., not busy), that all connections through the appropriate network or networks between the originating and destination devices either have been made or are available to be made, and that the call can be connected if someone or something answers the call. The nature of the ringback tone varies by region and country. In the United States, Canada, and other countries in the North American Numbering Plan (NANP), the standard PSTN ringback tone is generated by summing a 440-Hz tone with a 480-Hz tone and applying these to the telephone line in a two-second on and four-second off cadence. The ringback tone may be generated by the switch serving either the called party or the calling party, but it is not generated by the called telephone instrument or PBX. The ringback tone generally starts and stops at the same rate as the ringing tone of the called telephone, but generally is out of phase, i.e., staggered in time. Personalized ringback tones recently have become popular, especially with respect to cellular telephones. Dozens of music genres and hundreds of selections are commonly available for both the ringback tone and the ringing tone. The service generally is on a subscription basis and carries an additional charge per tone selected. It is possible to select up to 100 or so active ringback tones at any given time, to play different tones for different callers, and to vary the tone by time of day, perhaps to have one tone for business hours and another for all other times.

### SUMMARY OF THE INVENTION

Instead of the standard “ring ring” or custom ring back tones, a user (User B) can opt for an “AD tone” that is served from a server, from a Cloud, or from any other advertisement server. When another user (User A) calls User B, an advertisement will be heard by User A. When Users B answers the call, User A and User B are connected as usual and can start talking with UserB.

Carriers (both line based and wireless) and/or service providers may share revenue with User B when advertisements are selected as a ring back tone. These advertisements may be customized, based on one or more of the called party, the calling party, the location of the calling party, the caller ID of the calling party, the time of the call, the date of the call, and various other parameters. Advertisements may also have a lead generation mechanism built in that enables the advertisement recipient to get more information of that advertisement, receive a coupon, or to request a call back from a representative for the advertised service and/or product. For example, lead generation may inform the calling party and/or the called party, to “press 1 to receive a coupon.” In another example, the lead generation may inform the calling party and/or the called party, to “press 1 and someone will call you back.” In another example, the lead generation may inform the calling party and/or the called party, to “press 1 at the end of your call to connect to a sales representative.” In another example, the lead generation may inform the calling party and/or the called party, to “press 1 to be connected to a sales representative immediately.”

The same concept is applicable to the ring tone that User B hears when called by User A. For example, User B′s device plays an advertisement in place of the usual “ring.” These advertisements may be download to the user's apparatus ahead of time, for example at certain specific intervals, or may be downloaded “on the fly” via GPRS, WiMax, WiFi, Internet or any other means of transferring data, as applicable to the user's apparatus. This will provide a market for billions of advertisements every day, world wide. This approach may also be used with PBX and corporate communication systems.

In one embodiment, a system facilitates telephonic advertising. The system includes an advertisement server for selecting one or more advertisements for playing as telephonic tones by one or more service providers in relation to one or more subscribers of the service providers, and a tone manager, installed with each of the service providers, for inserting the one or more advertisements received from the advertisement server as one or more subscriber tones within the service provider.

In another embodiment, a method advertises over a telecommunication device. One or more audio advertisements are received from at least one advertiser, each audio advertisement having zero, one or more associated advertizing criteria. One or more user profiles defining advertisement options for a subscriber of a service provider are received. For each subscriber, zero, one or more of the audio advertisements are selected based upon the user profile and the advertizing criteria associated with the audio advertisements. The selected audio advertisements are installed as one or more of dial tone, ring tone, call tone and busy tone for the subscriber.

In another embodiment, a software product has instructions, stored on computer-readable media, wherein the instructions, when executed by a computer, perform steps for telephonic advertising, including: instructions for receiving one or more audio advertisements from at least one advertiser, each audio advertisement having zero, one or more associated advertizing criteria; instructions for receiving one or more user profiles defining advertisement options for a subscriber of a service provider; instructions for selecting, for each subscriber, zero, one or more of the audio advertisements based upon the user profile and the advertizing criteria associated with the audio advertisements; and instructions for installing the selected audio advertisements as one or more of dial tone, ring tone, call tone and busy tone for the subscriber

### BRIEF DESCRIPTION OF THE FIGURES

FIG. 1 shows one exemplary system for tone based telephonic advertising, in an embodiment.

FIG. 2 shows one exemplary process for tone based advertising, in an embodiment.

FIG. 3 shows the advertising database of FIG. 1 in further detail.

### DETAILED DESCRIPTION OF THE FIGURES

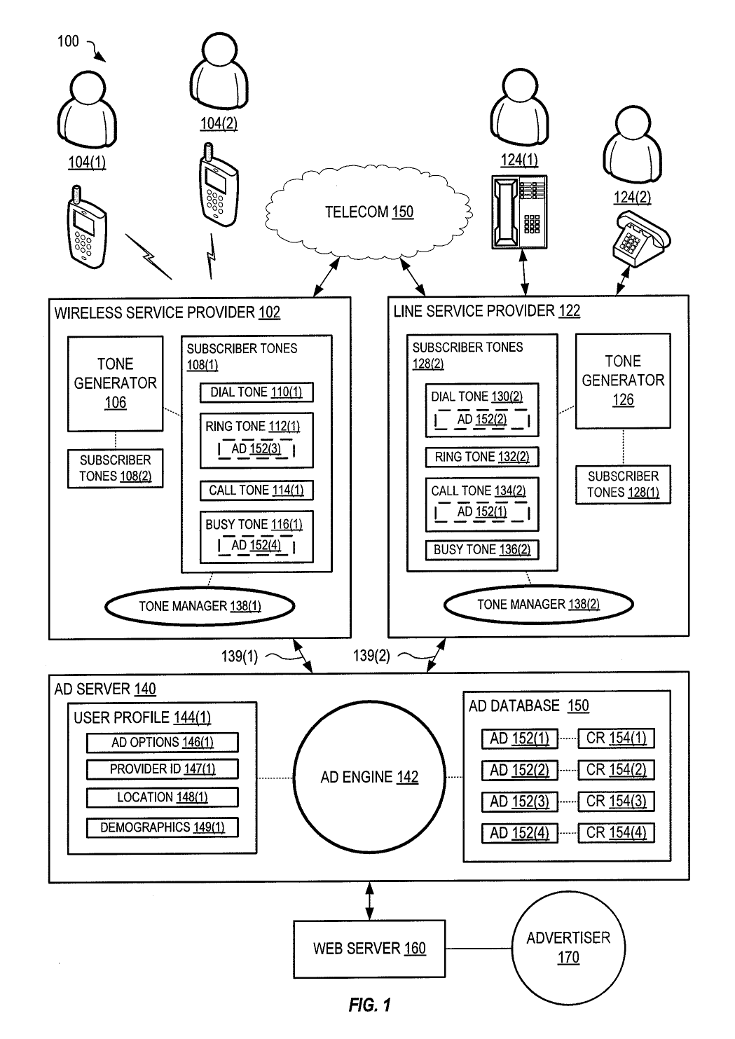

FIG. 1 shows one exemplary system 100 for tone based telephonic advertising, in an embodiment. A wireless service provider 102 is shown with two subscribers 104(1) and 104(2) and a PSTN switch 122 is shown with two line based subscribers 124(1) and 124(2). Service provider 102 may represent any wireless telephone communication provider, such as T-Mobile™, Verizon™, Sprint™, etc. PSTN switch 122 may represent any line based telecommunication provider, such as Qwest™, Southwest Bell™, etc. Service providers 102, 122 may also represent Internet service providers that provide voice over Internet protocol (VOIP) based telecommunication services.

In one embodiment, one or more advertisements 152 are preloaded onto apparatus (e.g., mobile phone, smart phone, PDA) of one or more subscribers 104, 124, and are selectively played under control of provider 102 and 122, respectively. In another embodiment, providers 102 and 122 stream the audio of the advertisements to subscribers 104, 124, respectively, where the audio is immediately played. In one embodiment, apparatus of subscribers 104, 124 each include one or more applications for managing and playing advertisements.

System 100 includes an advertisement server 140 that manages advertisement selection for participating subscribers (e.g., subscribers 104 and 124). In particular, advertisement server 140 includes an advertisement engine 142 that selects, from an advertisement database 150, advertisements 152 based upon associated advertisement criteria 154 and user profiles 144. Each service provider 102, 122, includes a tone manager 138 that interfaces, via a communication path 139, with advertisement server 140 to facilitate configuration of advertisements 152 as subscriber tones 128. Communication path 139 may represent one of GPRS, WiMax, Internet, wired or any other means of transferring data. Advertisement database 150 is shown with advertisements 152(1), 152(2), 152(3) and 152(4) that are associated with advertisement criteria 154(1), 154(2), 154(3) and 154(4), respectively.

In the example of FIG. 1, user profile 144(1) represents user profile information associated with subscriber 104(1). Advertisement server 140 may contain profiles for each of subscribers 104 and 124. User profile 144(1) is shown containing advertisement options 146(1) that indicate advertisement participation agreements and preferences of subscriber 104(1), a provider ID 147(1) that identifies wireless service provider 102, a location 148(1) that defines a current location (or an approximate area) of subscriber 104(1) and demographics 149(1) that define demographic information (e.g., age, gender, etc.) of subscriber 104(1).

Advertisement engine 142 evaluates criteria 154 and each user profile 144 to select zero, one or more advertisements for each subscriber 104, 124. Where multiple advertisements are selected for any one subscriber, advertisement engine 142 may sequence through the selected advertisements based upon one or more of play time, play occurrences, and availability for play time.

Advertisement options 146 may specify one or more of dial tone 110, 130, ring tone 112, 132, call tone 114, 134, and busy tone 116, 136 of subscriber tones 108, 128, respectively, for playing advertisements 152. As shown in FIG. 1, subscriber tones 108(1) of subscriber 104(1) has advertisement 152(3) playing as ring tone 112(1) and advertisement 152(4) playing as busy tone 116(1).

In an alternate embodiment, subscriber tones are collectively configured for a plurality of subscribers, such that the plurality of subscribers may play the same advertisement through a single advertisement configuration by the tone manager.

In one example of operation, subscriber 124(2) lifts the handset to place a call to subscriber 104(1). Subscriber 124(2) hears advertisement 152(2) instead of the default dial tone associated with line service provider 122. Once subscriber 124(2) starts dialing the phone number associated with subscriber 104(1), advertisement 152(2) stops playing, as occurs with a default dial tone. Assuming, for this example, that subscriber 104(1) is already in a call, when subscriber 124(2) completes entry of the phone number and a connection is made to wireless service provider 102, subscriber 124(2) hears advertisement 152(4) generated by tone generator 106 of wireless service provider 102. On the other hand, assuming subscriber 104(1) is not making a call, subscriber 124(2) hears the default call tone 114(1) generated by tone generator 106 and subscriber 104(1) hears advertisement 152(3) generated by tone generator 106. When subscriber 104(1) answers the call, playing of advertisement 152(3) stops, and the call from subscriber 124(2) to subscriber 104(1) is established.

In another example of operation, subscriber 104(1) dials a phone number of subscriber 124(2). Since subscriber 104(1) is wireless, subscriber 104(1) does not hear a dial tone. Assuming that subscriber 124(2) does not have another call in progress, as wireless service provider 102 connects to line service provider 122, subscriber 104(1) hears advertisement 152(1) generated by tone generator 126. On the other hand, if subscriber 124(2) does have another call in progress, subscriber 104(1) hears the normal busy tone 136(2) generated by tone generator 126.

Advertisement server 140 may connect to a web server 160 that allows one or more advertisers 170 to provide advertisements 152 and advertisement criteria 154 to advertisement server 140. For example, web server 160 may be configured with account information that requires advertiser 170 to login to web server 160 and thereby manage advertisements 152 and criteria 154 relating to advertiser 170.

Web server 160 may also allow subscribers 104, 124 to enroll in services provided by system 100. For example, subscribers 104, 124 may receive discounts from service providers 102, 122 when enrolled in system 100. Further, service providers 102, 122 may receive revenue from system 100, based upon the number of advertisements 152 played for example.

In an embodiment, tone managers 138 interact in real-time with advertisement engine 142, when calls are made by subscribers 104, 124, to retrieve one or more advertisements 152 based upon associated criteria 154 and user profiles 144. For example, when subscriber 104(2) places a call to subscriber 124(1), tone manager 138(1) interacts with advertisement engine 142, which selects one or more advertisements 152 (based upon associated criteria 154 and user profile 144) for playing to subscriber 104(2) as a call tone. Upon receiving call information from wireless service provider 102, line service provider 122 notifies tone manager 138(2), which then interacts with advertisement engine 142 to receive one or more advertisements 152 (based upon associated criteria 154 and user profile 144) for playing to subscriber 124(1) as a ring tone.

Since a ring tone is typically generated by a handset (e.g., a cell phone or standard end user telephone apparatus), the advertisement is transferred to the handset for playing. This transfer may be through the existing network of the service provider or by any other data transfer means, such as GPRS, WiMax, and the Internet. Ring tone based advertisements may be periodically sent to the handset irrespective of whether they are used. Particularly, where one advertisement currently installed on a handset expires, advertisement server 140 may automatically send a new ring tone to the handset.

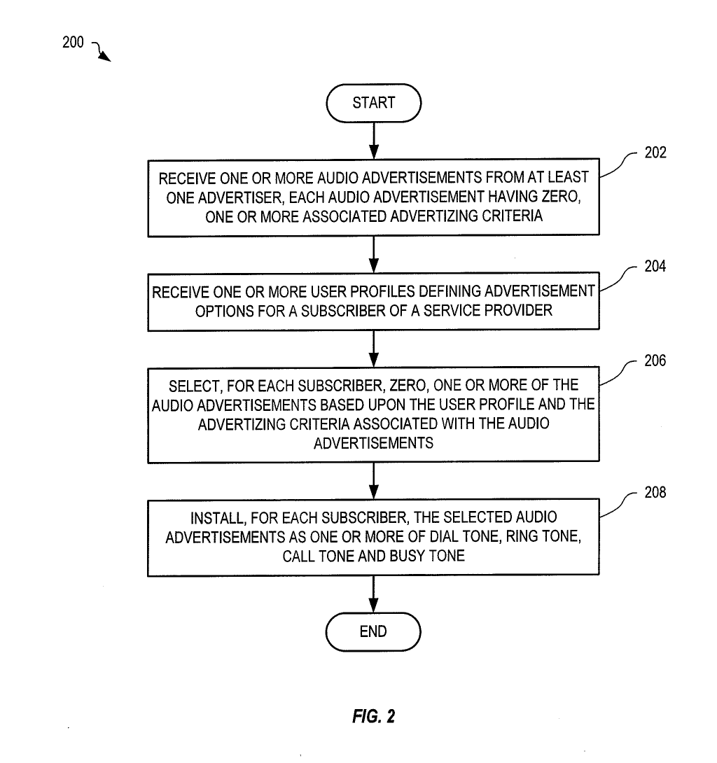

FIG. 2 shows one exemplary process 200 for tone based advertising. In step 202, process 200 receives one or more audio advertisements from at least one advertiser, each audio advertisement having zero, one, or more, associated advertising criteria. In one example of step 202, advertising server 140 receives, via web server 160, advertisements 152 and associated criteria 154 from advertiser 170. In step 204, process 200 receives one or more user profiles defining advertisement options for a subscriber of a service provider. In one example of step 204, advertisement server 140 receives one or more user profiles 144 interactively via web server 160 as subscribers 104, 124 enroll to receive advertisements from system 100. In step 206, process 200 selects, for each subscriber, zero, one, or more, of the audio advertisements based upon the user profile and the advertizing criteria associated with the audio advertisement. In one example of step 206, advertisement engine 142 selects zero, one or more advertisements 152 from advertisement database 150 based upon user profiles 144 and criteria 154 associated with advertisements 152. In step 208, process 200 installs, for each subscriber, the selected audio advertisements as one or more of dial tone, ring tone, call tone, and busy tone. In one example of step 208, advertisement engine 142 sends advertisements 152 to tone managers 138 for installing within subscriber tones 108, 128 as one or more of dial tone 110, 130, ring tone 112, 132, call tone 114, 134 and busy tone 116, 136.

Ordering of steps within process 200 may change without departing from the scope hereof. For example, steps 202 and 204 may be interchanged. Further, steps 202 and 204 may each occur one or more times as subscribers and advertisers interact with web server 160. Steps 206 and 208 may repeat to select alternative advertisements based upon associated criteria and time.

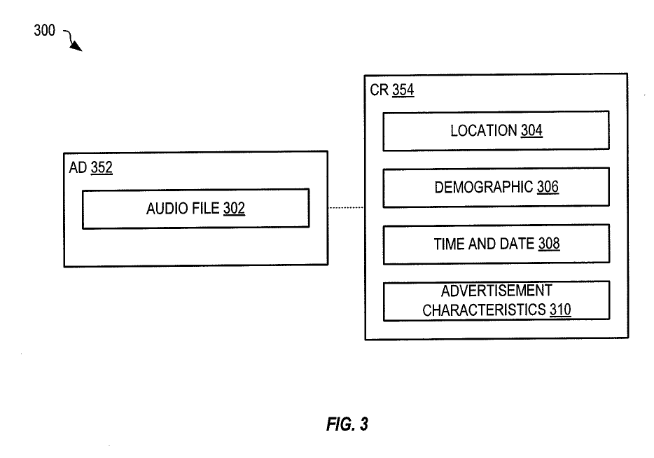

FIG. 3 shows exemplary structure 300 of an advertisement 352 and associated criteria 354. Advertisement 352 and criteria 352 may represent advertisements 152 and criteria 154 of FIG. 1. Advertisement 352 includes an audio file 302 that is a digital representation of audio for advertisement 352. Criteria 354 is shown with exemplary data fields of a location 304, a demographic 306, a time and date 308 and advertisement characteristics 310. Location 304 may specify a geographic area in which the recipient of the associated advertisement 352 is currently located. Demographic 306 may specify one or more recipient characteristics, or ranges of characteristics, to which advertisement is aimed. Time and date 308 may specify one or more time ranges (e.g., time of day and/or days of the week) during which the associated advertisement 352 is to be played and/or an expiration date and/or time for the advertisement, after which it is not to be played. Advertisement characteristics 310 may specify one or more characteristics of the associated advertisement 352 that allow advertisement engine 142, FIG. 1, to select advertisement 352 based upon non-recipient related data.

In one example, subscriber 104(1) places a call to subscriber 124(2) and hears advertisement 152(1) as a call tone (ring back tone). Having interest in the information of advertisement 152(1), subscriber 104(2), presses a numeric key on the keypad of their apparatus, and provider 102 records this request for information in association with advertisement 152(1). Service provider 102 may send this information request to ad server 140 whereupon an appropriate response is determined based upon user profiles 144 and/or associated criteria 154 of ad database 150. In one example, ad server 140 generate and send one or more of a text message and an email message to subscriber 104(1). Ad server 140 may also contact advertiser 170 (e.g., a text message, an email message, updating status on web server 160 in association with advertiser 170, and/or other communication means) to indicate the interest of subscriber 104(1) in advertisement 152(1). Advertiser 170 may then directly call subscriber 104(1) or schedule other means of follow up with subscriber 104(1).

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for telephonic advertising, comprising:
an advertisement server for selecting one or more advertisements for playing as telephonic tones by one or more service providers in relation to one or more subscribers of the service providers;
a tone manager, installed with each of the service providers, for inserting the one or more advertisements received from the advertisement server as one or more subscriber tones within the service provider.

2. The system of claim 1, the subscriber tones being selected from the group including dial tone, ring tone, call tone and busy tone.

3. The system of claim 1, wherein the one or more advertisements are downloaded to a handset of the subscriber when selected for playing as a ring tone, the subscriber being a called party.

4. The system of claim 1, the advertisement server comprising an advertisement engine for selecting the one or more advertisements based upon associated advertisement criteria.

5. The system of claim 4, the advertisement criteria being selected from one or more of (a) a called subscriber location, (b) a calling subscriber location, (c) subscriber demographic information, (d) time and date, and (e) subscriber advertisement options.

6. The system of claim 4, further comprising a web server for interacting with one or more advertisers to receive the one or more advertisements and associated advertisement criteria.

7. The system of claim 1, wherein the tone manager is configured to determine subscriber tone play statistical information from the service provider for subscriber tones having advertisements and for sending the statistical information to the advertisement server.

8. The system of claim 1, wherein the tone manager is configured to determine geographical location information of a mobile subscriber when the service provider is a wireless service provider, and to send the geographical location information to the advertisement server.

9. The system of claim 1, the one or more service providers being selected from the group including a wireless service provider, a line service provider, and an Internet service provider.

10. The system of claim 1, the advertisement comprising lead generation to instruct the subscriber how to respond to the advertisement;

11. The system of claim 10, wherein the advertisement server is configured to send a message to an advertiser associated with the advertisement in response to receiving notification of the subscriber pressing a key in response to the lead generation.

12. The system of claim 11, the message comprising a phone number of the subscriber.

13. A method for advertising over a telecommunication device, comprising:
receiving one or more audio advertisements from at least one advertiser, each audio advertisement having zero, one or more associated advertizing criteria;
receiving one or more user profiles defining advertisement options for a subscriber of a service provider;
selecting, for each subscriber, zero, one or more of the audio advertisements based upon the one or more user profiles and the associated advertizing criteria; and
installing the selected audio advertisements as one or more of dial tone, ring tone, call tone and busy tone for the subscriber.

14. The method of claim 13, further comprising sending, based upon a response of the user to a lead generation within one of the advertisements, a message to the at least one advertiser, the message indicating the user interest in the one or more audio advertisements.

15. A software product comprising instructions, stored on computer-readable media, wherein the instructions, when executed by a computer, perform steps for telephonic advertising, comprising:
instructions for receiving one or more audio advertisements from at least one advertiser, each of the one or more audio advertisements having zero, one or more associated advertizing criteria;
instructions for receiving one or more user profiles defining advertisement options for a subscriber of a service provider;
instructions for selecting, for the subscriber, zero, one or more of the audio advertisements based upon the user profile and the one or more associated advertizing criteria; and
instructions for installing the selected audio advertisements as one or more of dial tone, ring tone, call tone and busy tone for the subscriber.
